(19) United States
(12) Patent Application Publication
(10) Pub. No.: US 2014/0212375 A1
(43) Pub. Date: Jul. 31, 2014

(54) Feeding attractant of Spodoptera liturae larva and use thereof

(71) Applicant: NATIONAL TAIWAN UNIVERSITY, Taipei City (TW)

(72) Inventors: Hung-Yuan Chen, Taipei City (TW); En-Cheng Yang, Taipei City (TW)

(73) Assignee: NATIONAL TAIWAN UNIVERSITY, Taipei City (TW)

(21) Appl. No.: 14/083,353

(22) Filed: Nov. 18, 2013

(30) Foreign Application Priority Data
Jan. 25, 2013 (TW) 102102844

(51) Int. Cl. A01N 65/44; A01N 63/00

(52) U.S. Cl. CPC A01N 65/44; A01N 63/00
USPC 424/84

(57) ABSTRACT

The present invention relates to an attractive composition comprising wheat germ alcohol extracts, which is used as a feeding attractant for larvae of Spodoptera liturae. The present invention also provides a method for usage of the said attractive composition.

### FIELD OF THE INVENTION

The present disclosure relates to a novel attractive composition comprising wheat germ alcohol extracts, which is used as a feeding attractant to actively attract the larva of various pests, and methods for use thereof.

### BACKGROUND OF THE INVENTION

Spodoptera litura belongs to the order of Lepidoptera, and is a devastating pest around the globe. Feeding habits of the larva are extremely diverse. Primary instar larvae inhabit the dorsal side of leaf, graze the mesophyll and leave the transparent upper epidermis. The third instar larvae start to scatter, and the fourth instar larvae become to hide diurnally and feed nocturnally. Targets of larvae include various crops, horticultural plants and even weeds in Orchidaceae, Iridaceae, Gentianaceae, Apocynaceae, Asteraceae, Rosaceae, Araceae, Caryophyllaceae, Amaranthaceae, Nymphaeaceae, Brassicaceae, Poaceae, Cucurbitaceae, Convolvulaceae, Liliaceae, Solanaceae, Amaryllidaceae, Fabaceae, Malvaceae, Theaceae, Ebenaceae and Rutaceae.

For farmers, the major damage caused by Spodoptera litura comes from the larvae's feeding habits, which is described as “will eat whatever is green”, and the larvae will consume a great mass of the plants.

Because the larvae of Spodoptera litura are polyphagous, and the imagoes can fly and disperse quickly, hence it is difficult to control their damage. So far, the treatments against the larvae of Spodoptera litura are based on biological and chemical pest control methods. However, these kinds of methods are passive, require to be spread massively and artificially. Furthermore, before the larvae contact the predators, pathogens or pesticides, the crops are usually damaged by larvae already, and their economical value is reduced. Besides, chemical methods often lead to environmental pollution and pesticide residues. Therefore, how to control the problems caused by the larvae of Spodoptera litura while taking the environment protection into account is a serious worldwide issue.

So far, there is no attractant aiming for the larvae of Spodoptera litura. The lure methods used today are basically the application of sex pheromone, which actively attracts the male adults and reduces their mating rate, eventually, decreases the fecundity and amount. However, this kind of methods does not ameliorate the damage created by the larvae already existing.

With chemical pest control methods, massive amount of pesticide is sprayed, although 100% mortality rate can be achieved in the beginning, it leaves the pollution in the environment and residues on the crops, which is not only harmful to health but also speeds up larvae's development of resistance to pesticides. Thus there are still many issues to be dealt with in chemical pest control methods.

On the other hand, biological pest control methods, such as the use of predators, for example, Eocanthecona furcellata; or parasites, for example, Snellenius manila or entomopathogenic nematodes. However, the application of this kind of methods requires massive release of the said predators or parasites. The temperature, humidity, time of release, open space and the adaptability to environment will influence the successful rate. Moreover, the control efficacy will also depend on the environment, plant species, local ecological condition, insect fauna and whether there are other kinds of predators or parasites. Thus the applicability of these methods is rather limited. Therefore, although their impact to the nature is less, and they will bring no chemical pollution, their prevalence rate is low, and the cost is high.

Microorganism pest control methods mainly use the entomopathogenic fungi , including Metarhizium anisopliae or entomopathogenic viruses, including nucleopolyhedrovirus (NPV) as the controlling agents, however, this kind of methods is effective only when the larvae ingest the pathogens. Similarly, the viability of the pathogens is susceptible to various factors; even when the condition is optimal, if the larvae do not ingest the pathogens or ingest insufficient pathogens, the controlling effect will be greatly reduced.

US2006/0177474 discloses a bait formulation for insect pest including Spodoptera litura, which comprises rice bran and/or sake lees as the edible carrier, and pesticide. Applicant notes that there are several ways in food seduction, including palatability, visual attraction and olfactory attraction. Among them, only olfactory attraction possesses long-distant attraction effect, it is also the first stimuli the larvae receive during their foraging. US2006/0177474 does not disclose the principle on which the said application depends. Its bait is still the food of larvae, and the larvae might contact the bait or crops during crawling. Thus the seductive properties of the disclosed bait might be simply arising from random contact and trial behavior of larvae (the larvae are polyphagous, basically they will test the food by a bite to see if it is edible), there is no evidence suggesting that the larvae actively crawl to the bait and ingest all or most of the bait. Besides, applicant indicates that the pesticides used in the said disclosure are rather strong. Even if the bait itself lacks the seductive properties and is bitten a little due to random trial, it will still cause the direct death of larvae. This will be misjudged that the bait possesses good seductive effect. In other words, the bait disclosed by US2006/0177474 could simply have good poisoning effect, rather than good seductive effect. Furthermore, the disclosure does not include the embodiments of practical application in the fields, so it might be spread on the soil and crops in large quantity, the larvae will inevitably contact the bait and be killed, but not be seduced.

In addition, US2006/0177474 discloses the attractant in the bait can include wheat germ oil, which is produced through mechanical pressing or solvent extraction of wheat germ, the main ingredients include oleic acid, linoleic acid, stearic acid, lecithin, octacosanol and compounds with carbon number more than 18. Because the pressing or extraction procedures allow volatile small molecules dissipate easily, or be broken down by heat or pressure, the wheat germ oil rarely contains any alkene or alcohol molecules with carbon number below 10.

### SUMMARY OF THE INVENTION

Disclosed herein is an attractive composition for attracting a larva of an insect, particularly the larva of Spodoptera litura, wherein the attractive composition comprises wheat germ alcohol extracts.

Also disclosed herein is a method for controlling a larva of an insect, particularly the larva of Spodoptera litura, wherein the method comprises applying the attractive composition of the present invention alone or in combination with different insect controlling agents, at the area infested by the larvae, allowing the larvae to ingest the attractive composition.

### BRIEF DESCRIPTION OF THE DRAWINGS

FIG. 1 shows the preference test of the larvae of Spodoptera litura for different kinds of leaves.

FIG. 2 shows the results of the preference test shown in FIG. 1.

FIG. 3 shows the device for scent preference test.

FIG. 4 shows the results of the scent preference test shown in FIG. 3.

FIG. 5 shows the attraction capability results of different kinds of wheat germ extracts and the attractive composition of the present invention.

FIG. 6 shows the application of attractive composition of the present invention.

FIG. 7 shows the desiccated attractive composition (left), and the attractive composition after soaking in water for 30 minutes, which can then be ingested by larvae (right).

### DETAILED DESCRIPTION

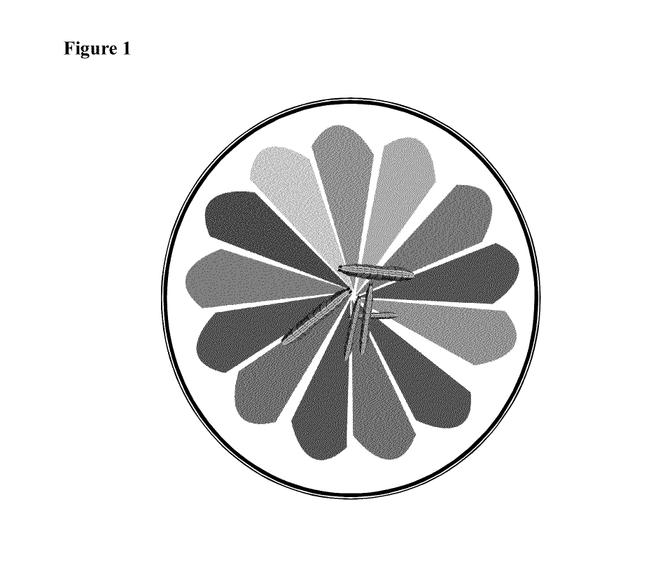

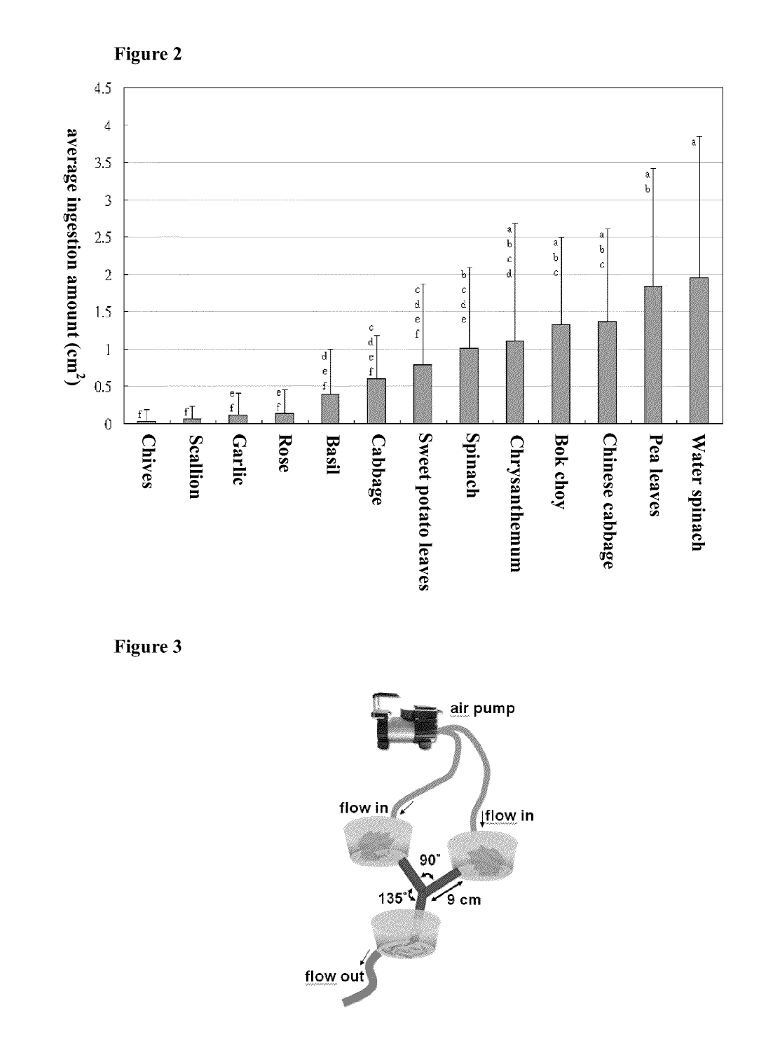

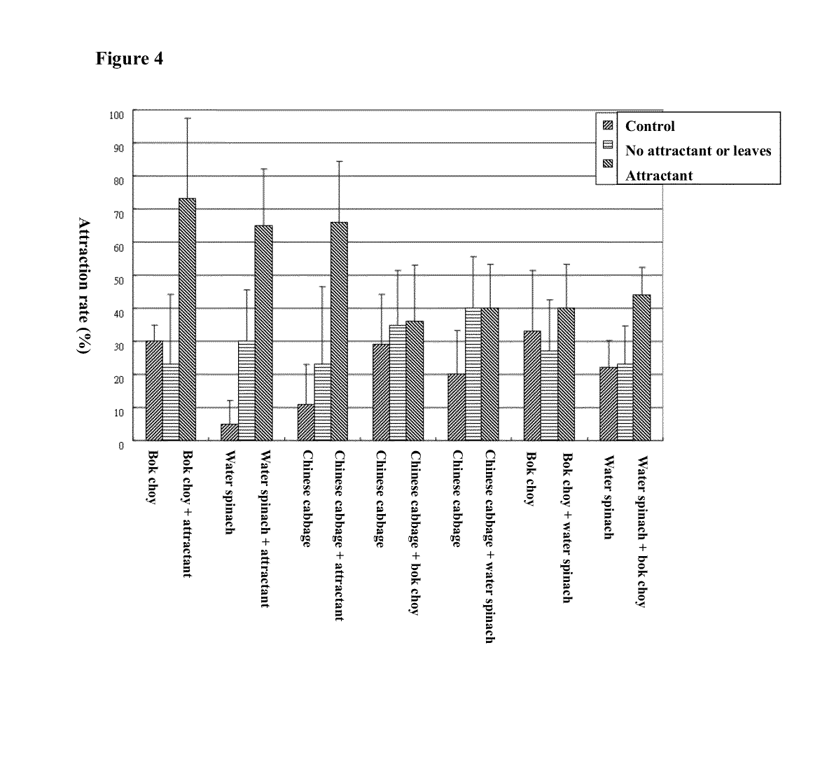

The applicant observed the foraging behavior of the larvae of Spodoptera litura, the conclusions were:
a. The foraging behavior of 80% of the larvae occurred during 4:00-7:00AM and 6:00-8:00PM, the intensity of light would affect the foraging behavior, the brighter the environment was, the fewer foraging behavior the larvae exhibited.
b. The larvae were polyphagous, they would bite almost anything they encountered during the foraging. If they were very hungry, they would even bite non-edible matter, such as styrofoam or filter paper. This showed that the larvae determined if something was edible by biting.
c. The experiment results showed that although the larvae were polyphagous, they still had some preference, when there were only leaves of pungent plants, such as basil, scallion, garlic and the like or rose, the larvae would ingest them, even all of them. But if there were other kind of leaves, such as cabbage or bok choy, then the larvae would continue to search after trying the pungent plants; finally, as they encountered the cabbage or bok choy, they would stop to ingest the leaves until they are fed. In other words, as shown in FIGS. 1 and 2, under the coexistence of plural food, the pungent plants might simply be the leaves randomly encountered and bitten by the larvae; and the loss of scent gradient due to other plants in the same testing environment would affect the olfactory searching capability of larvae.
d. After the test with coexistence of 13 kinds of vegetables, the results showed that although Spodoptera litura was polyphagous, it still exhibited preference, and would cause severe damage to the preferred plants. The foraging preference depended on the palatability judged by random bite, or the attraction of various scents. Hence in the further behavioral test, the larvae were placed in an environment without any vegetable or plants, yet they were able to smell different kinds of scents, as shown in FIG. 3.
e. In the test with Y-shaped tunnels, the larvae were placed at the starting point where there was without any food, their preference would be influenced only by the scents. In FIG. 4, the results showed that the larvae possessed olfactory preference, and the attractive composition of the present invention showed significant capability of attracting larvae, which proved that scents were the basis for the larvae to forage.

The present invention provides an attractive composition for attracting a larva of an insect, which comprises wheat germ alcohol extracts. In a preferred embodiment, the attractive composition further comprises an agriculturally acceptable carrier from about 80 to about 99 wt %, wherein the carrier comprises a vehicle, an antioxidant or a preservative.

As used herein, the term “agriculturally acceptable carrier” indicates any substance that is capable of dissolving, dispersing or diffusing the active ingredient in the composition, and will not interfere with the effectiveness of the active ingredient, and the substance itself will not degenerate the earth, equipment, plants or the environment.

If necessary, the traditional auxiliary agents, such as surfactants, stabilizers, foam removal agent or antidrift agent may be added in the said composition.

The attractive composition of the present invention is an aquatic solution, dispersion liquid, oily solution, oily dispersion liquid, serous fluid, dusting powder, wettable powder, emulsifiable concentrate, flow agent, particle, bait and invert emulsion. The wettable powder, serous fluid, flow agent and emulsifiable concentrate are all concentrated preparation; they need to be diluted by water before or during use. If necessary, the composition of the present invention also includes dyes, such as inorganic or organic dyes, and trace amount of salts, such as iron, manganese, boron, copper, cobalt, molybdenum and zinc. In a preferred embodiment, the feeding attractive composition is block-shaped and desiccated, which needs to be soaked with water before use.

It is noted that in the feeding attractive composition of the present invention, the concentration of active ingredient (wheat germ alcohol extracts) will depend on the type of the equipments, methods of application, area to be treated, types of the pests to be controlled, extent of the damage and the like. Hence, under special circumstances, concentration higher or lower than the previously described one is used. In a preferred embodiment, the wheat germ alcohol extracts are obtained by soaking the wheat germ with alcohol, the ratio of volumes of wheat germ to alcohol is from about 1:4 to about 4:1. In a more preferred embodiment, the ratio of volumes of wheat germ to alcohol is from about 1:2 to about 2:1. In the most preferred embodiment, the ratio of volumes of wheat germ is about 1:1.

In another preferred embodiment, the insect belongs to Lepidoptera, such as Pectinophora gossypiella, Bupalus piniarius, Cheimatobia brumata, Lithocolletis blancardella, Hyponomeuta padella Linnaeus, Plutella stella, Malacosoma neustria testacea Motschulsky, Euproctis chrysorrhoea, Lymantria, Bucculatrix thuberiella Busck, Phyllocnistis citrella, noctuids, Agrotis ipsilon, Spodoptera exigua Hiibner, Earias insulana (Boisd.), Helicoverpa armigera (Hubner), Mamestra brassicae, Panolis flammea, oriental armyworm, Trichoplusia ni, Cydia pomonella, Pieris rapae, Chilotraea auricilia, Ostrinia nubilalis (Hubner), Ephestia kuehniella Zeller, Galleria mellonella, Tinea pellionella, Tineola bisselliella, Cacoecia podana, Capua reticulana, eastern spruce budworm, grape bud moth, Tortricidae, Cnaphalocrocis medialis Guenee, Oulema oryzae (Kuwayama).

In another preferred embodiment, the pest is a moth. In the most preferred embodiment, the moth is Spodoptera litura.

The attractive composition of the present invention actively attracts the larvae by a scent.

The present invention also provides a method for attracting a larva of an insect, which comprises applying the attractive composition of the present invention at the area infested by the larva, allowing the larva to be attracted or to ingest the attractive composition. The said area includes the area where the larvae occupy or forage (e.g. plants, farmland, forest, orchard, aqueduct, earth and the like), or the area to be infested by the larvae. Hence, the method of present invention is applied to agriculture, horticulture, forestry, veterinary, husbandry or public health.

In a preferred embodiment, the insect is moth. In a more preferred embodiment, the moth is Spodoptera litura.

In another preferred embodiment, the attractive composition is further used as a carrier for a biologically-controlling pathogen or pesticide, which allows the larva to ingest the pathogen or pesticide actively, and to become sick or dead. The said biologically-controlling pathogen includes effective pathogens for controlling the larvae, including entomopathogenic bacteria, fungi, virus, protist and the like.

The said pesticides will not interfere or react with the active ingredient of the attractive composition of the present invention, which include, but are not limited to abamectin, acephate, acetamiprid, acrinathrin, alanycrb, aldicarb, allethrin, alpha-cypermethrin, aluminium phosphide, amitraz, azadirachtin, azamethiphos, azinphos-ethyl, azinphos-methyl, bendiocarb, benfuracarb, bensultap, beta-cyfluthrin, beta-cypermethrin, bifenthrin, bioallethrin, S-cyclopentenyl isomer, bioresmethrin, bisatrifluron, borax, buprofezin, butocarboxim, butoxycarboxim, cadusafos, calcium cyanide, calcium polysulfide, carbaryl, carbofuran, carbosulfan, cartap, chlosdane, chlorethoxyfos, chlorfenapyr, hlosfenvinphos, chlorfluazuron, chlormephos, chloropicrin, chlorpyrifos, chlorpyrifos-methyl, chromafenozide, clothianidin, coumaphos, cryolite, cyanophos, cycloprothrin, cyfluthrin, cyhalothrin, cypermethrin, cyphenothrin, cyromazine, dazomet, deltamethrin, demeton-S-methyl, diafenthiuron, diazinon, dichlorvos, dicrotophos, dicyclanil, diflubenzuron, dimethoate, dimethylvinphos, dinotefuran, disulfoton, emamectin, emamectin benzoate, empenthrin, endosulfan, esfenvalerate, ethiofencarb, ethion, ethiprole, ethoprophos, ethylene dibromide, etofenprox, etoxazole, famphur, fenitrothion, fenobucarb, fenoxycarb, fenpropathrin, fenthion, fenvalerate, fipronil, flonicamid, flucycloxuron, flucythrinate, flufenoxuron, flumethrin, formetanate, formetanate hydrochloride, fosthiazate, furathiocarb, halofenozide, heptachlor, heptenophos, hexaflumuron, hydramethylnon, hydroprene, imidacloprid, imiprothrin, indoxacarb, isofenphos, isoprocarb, O-(methoxy-acyl amino phosphorothioate)isopropyl salicylate, isoxathion, lambda-cyhalothrin, perfluorooctane sulfonate, lufenuron, magnesium phosphide, malathion, mecarbam, mercurous choride, metam, methamidophos, methidathion, methiocarb, methomyl, methoprene, methothrin, methoxychlor, methoxyfenozide, methyl isothiocyanate, metolcarb, mevinphos, milbemectin, monocrotophos, naled, naphthalenic compounds, nicotine, nitenpyram, nithiazine, novaluron, noviflumuron, omethoate, oxamyl, oxydemeton-methyl, parathion, methyl parathion, pentachlorophenol, permethrin, petroleum oils, phenothrin, phenthoate, phorate, phosalone, phosmet, phosphamidon, phoxim, pirimicarb, pirimiphos-methyl, prallethrin, profenofos, propaphos, propetamphos, propoxur, prothiofos, pymetrozine, pyraclofos, pyrethrine, pyridaben, pyridaphenthion, pyrimidifen, pyriproxyfen, quinalphos, resmethrin, rotenone, sabadilla, silafluofen, sodium cyanide, pentachlorophenyl sodium oxide, spinosad, sulcofuron, sulcofuron-sodium, sulfluramid, sulfotep, sulfuryl fluoride, sulprofos, tau-fluvalinate, tebufenozide, tebupirimfos, teblubenzuron, tefluthrin, temephos, terbufos, tetrachlorvinphos, tetramethrin, theta-cypermethrin, thiacloprid, thiamethoxam, thiodicarb, thiofanox, thiometon, thiosultap-sodium, tolfenpyrad, tralomethrin, transfluthrin, triazamate, triazophos, trichlorfon, triflumuron, trimethacarb, vamidothion, xylylcarb, zeta-cypermethrin and zinc phosphie.

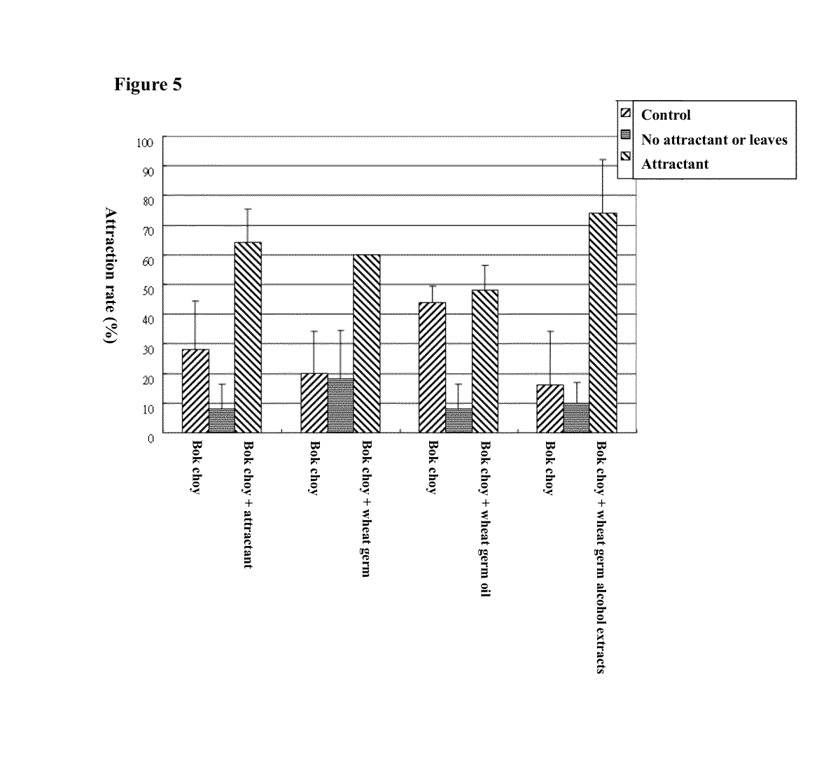

The attractive composition of the present invention attracts the larvae through the specific scent of the wheat germ alcohol extracts (FIG. 5). In the field, long-distance attraction of larvae is achieved mainly by the olfaction, not by vision or contact.

Hence, based on the foraging behavior, the present invention develops an attractive composition for the larvae of Spodoptera litura, wherein the attractive composition comprises the attractant that lures the larvae to ingest the attractant actively. Because of its characteristics, compared to the large-scale application required by conventional controlling methods, the attractive composition of the present invention needs to be spread only around the base of plants, and it will exert the great attractive effect, thus reducing the damage to the plants caused by larvae. Besides the use in gathering the larvae, the attractive composition of the present invention is also utilized as the carrier for pesticides or microbial pathogens that will cause the death of larvae, hence decreasing the amount of pesticides used and residues, leading to the refinement of agriculture.

Compared to US patent application No. 2006/0177474, the alcohol used in the present invention is industrial ethanol with 99% purity, and the volatile scent of the wheat germ was extracted by ethanol below 10° C. After analysis, the main components include alcohols, alkenes and esters, and the carbon numbers of all the compounds are less than 10, such as 2-methylbutyl acetate, β-phenylene, α-pinene, β-pinene, hexyl acetate, m-isopropyltoluene, p-isopropyltoluene, 2-methylbutyl butyrate, hexyl-2-methylbutyrate, terpinene, 3-careen, butyl hexanoate etc., all these are the products from the extraction by cold alcohol, thus the wheat germ alcohol extracts and wheat germ oil are two chemically different solution. As to the physical properties, the wheat germ oil is less volatile, does not possess significant scent; while the wheat germ alcohol extracts are highly volatile and flammable, possess strong scent and low boiling point, hence the properties of the wheat germ oil and wheat germ alcohol extracts are distinct.

In addition, the feeding attractive composition of the present invention utilizes the specific behavior of larvae, which is to be attracted by the scent, to attract the larvae to ingest the bait actively, therefore the attractive composition is scattered in a small amount.

From the chemical components, physical properties and seductive effect test, it can be seen that the wheat germ oil and wheat germ alcohol extracts are two different compositions.

Besides the use in gathering the larvae actively, the attractive composition of the present invention is also utilized as the carrier for pesticides or microbial pathogens that will cause the death of larvae, hence decreasing the amount of pesticides used, residues and costs.

### EXAMPLES

The examples below are non-limiting and are merely representative of various aspects and features of the present invention.

### Example 1

The Preference Test of the Larvae of Spodoptera litura

13 kinds of leaves were washed thoroughly before being placed in a round dish, including chives, scallion, garlic, rose, basil, cabbage, sweet potato leaves, spinach, chrysanthemum, bok choy, Chinese cabbage, pea leaves, water spinach. Ten third instar larvae were put onto the center of round dish (FIG. 1), and then the dish was kept in the dark. After two hours, the kinds and amount of ingested leaves were recorded. This experiment was performed at 5:00˜7:00 PM, and repeated for 26 times.

Among the 13 kinds of leaves, pea leaves, water spinach, Chinese cabbage, bok choy and chrysanthemum were more preferred by the larvae, and the most preferred was the water spinach, the ingested amount in a single time could be up to 47.82 cm², this results indicated that although the larvae were polyphagous, they still possessed preference. Although the water spinach had the highest average amount of consumption, yet during the 26 times of trials, the possibility of being ingested was 76%, and the highest was bok choy, which was up to 93% (FIG. 2). This indicated that the larvae showed high preference toward bok choy.

### Example 2

### The Attractive Capability Test of Different Wheat Germ Extracts

The present invention used wheat germ as the main attractive material. The active ingredients were purified or extracted with different solvents. The results showed that the cold alcohol extracts of wheat germ had the best scent-attractive effect, the attraction rate was up to 70%, which was better than that of the bok choy only (FIG. 5); on the other hand, the wheat germ oil did not demonstrate significant attractive effect, which indicated that the main attractive ingredients could be extracted by cold alcohol, but not oil. Obviously, the wheat germ alcohol extracts and wheat germ oil were two different materials.

The wheat germ alcohol extracts alone or the attractive composition of the present invention (including the wheat germ alcohol extracts and other substrates) both possess significant scent-attraction effect, thus the attractive composition of the present invention is used to lure the larvae of Spodoptera litura.

Similar tests also showed that the individual ingredient isolated from wheat germ alcohol extracts could not achieve significant attraction effect.

### Example 3

### The Preparation of Wheat Germ Alcohol Extracts

The main active ingredients in the attractive composition of the present invention were wheat germ alcohol extracts, which were prepared by soaking the wheat germ in alcohol directly, in order to dissolve all the ingredients that were able to dissolve in alcohol. The ratio of wheat germ and 97% alcohol was 1:1. After soaking for about 24 hours, as the color of the solution became golden, the solution could be used.

### Example 4

### The Preparation of the Attractive Composition

The main ingredients in the attractive composition of the present invention were:
A. bean dregs 30 g, rice bran 5 g, wheat bran 35 g, crude yeast powder 5 g, agarose 3 g, carboxymethyl cellulose 1 g, carragheenate 2 g, dd water 300 mL;
B. vitamin C 1 g;
C. benzoic acid 0.4 g, sorbic acid 0.1 g, wheat germ alcohol extracts 50 mL;
D. 24% formali 0.7 mL.

The preparation steps are:
1. the composition A was blended homogenously and heated slowly, the blending was continued until the agarose dissolved and the composition became sticky;
2. the composition C was blended homogenously until it dissolved completely;
3. when the composition A was cooled below 50° C., the compositions B, C and D were added into composition A and blended homogenously;
4. the overall composition was poured into a container and refrigerated under 4° C. temperature;
5. the composition was cut into cubes with the size of about 1 cm³ after it was solidified;
6. the attraction composition cubes were dried under the temperature of 40° C. for about 2 hours, until the texture of the cubes was harden and the color turned into dark brown;
7. before use, the attraction composition cubes needed to be soaked in water for about 2 hours, until these cubes were adequately infiltrated (FIG. 7). Then in combination with the proper application methods, the attraction composition of the present invention could be used to lure and gather the larvae.

### Example 5

### The Test of Larvae's Preference Degree to Various Scents

1. FIG. 3 shows the Y-shaped tunnels, which was the device for testing larvae's preference to various scents. The leaves of bok choy, and the attractant of the present invention+bok choy were placed into the two chambers, respectively, and the air pump was turned on to make the air flow. 10 larvae over third instar phase were put into the rear chamber, which was without any food. Under this condition, the larvae could only crawl to the preferred food source by following its scent, but not by sight or direct contact. The test was repeated with other kinds of leaves, including water spinach and cabbage. This device could be used to determine larvae's preference degree to various scents.
2. Results: Compared to bok choy, water spinach and cabbage, the attractant of the present invention possessed significant capability to attract the larvae (FIG. 4); however, the comparisons between any pair of these three vegetables did not show that one pair possessed significant capability to attract the larvae. The results demonstrated that the attractant of the present invention was better than bok choy in terms of attracting the larvae by scent.

### Example 6

The Application Methods of the Attractive Composition of the Present Invention and their Effects

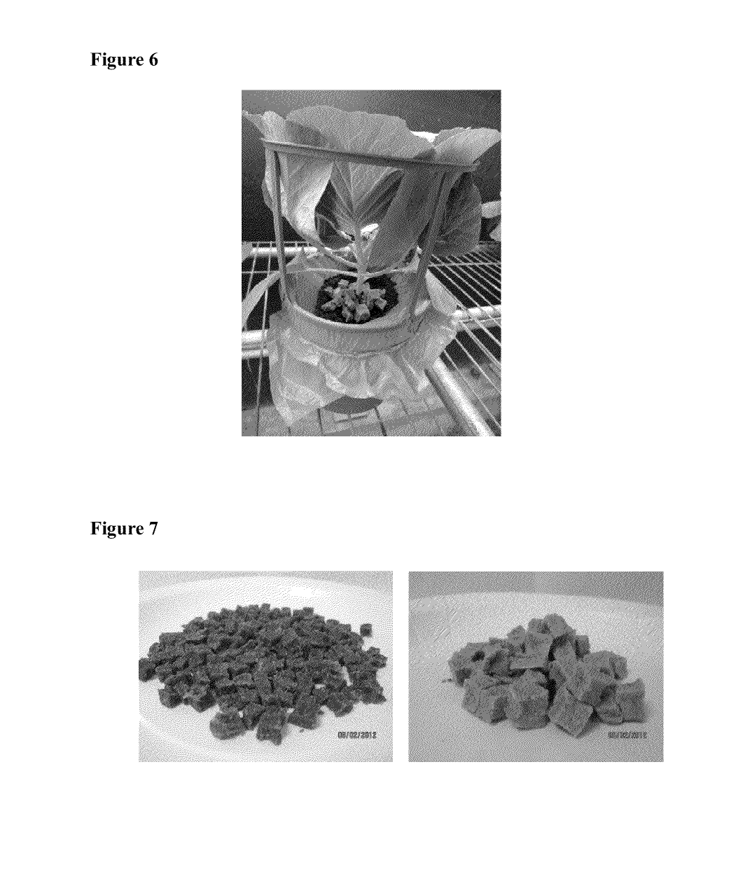

The potted young cabbages grown in a green house were divided into 4 groups for different application methods.
1. The 4 groups are:
   a. control: no treatment;
   b. attractive composition: 10 g (dry weight) of attractive composition was soaked in dd water for 30 minutes, and then 10-20 cubes of the attractive composition were placed onto the surface of earth around each plant's base (as shown in FIG. 6). The attractive composition was replaced with new one every 4 days;
   c. attractive composition with virus: the preparation was the same as group 2, except the soaking solution was entomopathogenic virus solution instead of dd water, the concentration of virus was 10⁷OB/mL;
   d. direct spraying of virus: entomopathogenic virus solution (concentration of virus was 10⁷OB/mL) was directly sprayed onto the leaves of the cabbage until the leaves were completely wet; the virus solution was sprayed once every 4 days.
2. Results in 14 days after treatment:
   (1) Mortality rate (%)
      a. control: 7.0%±4.5 a
      b. attractive composition: 36.7%±9.5 b
      c. attractive composition with virus: 96.3%±2.4 c
      d. direct spraying of virus: 100% c
   (Means±SE in the same column at same day followed by different letters were significantly different among treatments by using Tukey-Kramer method, P<0.01)
   (2) Amount of ingestion (cm²)
      a. control: 2132.79±129.82 a
      b. attractive composition: 754.83±67.37 b
      c. attractive composition with virus: 125.67±24.15 c
      d. direct spraying of virus: 915.26±142.33 b
   (Means±SE in the same column at same day followed by different letters were significantly different among treatments by using Tukey-Kramer method, P<0.01)
   (3) Discussion

In terms of mortality rate, the group of attractive composition with virus showed high death rate, and was significantly different from that of the group of control and attractive composition. Thus the application method of attractive composition with virus was an effective controlling method. On the other hand, in terms of ingestion amount, attractive composition alone had reduced the ingestion amount, and provided protection to the leaves. When it was in combination with the virus, the ingestion amount was even substantially decreased, because the larvae would be sick after ingesting the attractive composition with virus. Although the direct spraying of virus had the highest mortality rate, the leaves were still being ingested extensively by larvae before the virus exerted its effect on larvae.

What is claimed is:

1-10. (canceled)

11. A method for attracting a larva of an insect, which comprises applying an attractive composition comprising wheat germ alcohol extract at an area infested by the larva, allowing the larva to be attracted by or ingest the attractive composition.

12. The method of claim 11, wherein the attractive composition further comprises an agriculturally acceptable carrier from about 80 to about 99 wt %, wherein the carrier comprises a vehicle, an antioxidant or a preservative.

13. The method of claim 11, wherein the wheat germ alcohol extract is obtained by soaking the wheat germ with alcohol, the ratio of volumes of wheat germ to alcohol is from 1:4 to 4:1.

14. The method of claim 11, wherein the wheat germ alcohol extract is obtained by soaking the wheat germ with alcohol, the ratio of volumes of wheat germ to alcohol is from 1:2 to 2:1.

15. The method of claim 11, wherein the insect is a moth.

16. The method of claim 15, wherein the moth is Spodoptera litura.

17. The method of claim 11, wherein the attractive composition actively attracts the larvae by a scent.

18. The method of claim 12, wherein the attractive composition is further used as a carrier for a biologically-controlling pathogen or pesticide, which allows the larva to ingest the pathogen or pesticide actively, and to become sick or dead.

19. The method of claim 18, wherein the biologically-controlling pathogen is an entomopathogenic fungus, virus, bacterium or nematode.
